(19) United States
(12) Patent Application Publication
(10) Pub. No.: US 2019/0141282 A1
(43) Pub. Date: May 9, 2019

(54) INFORMATION PROCESSING APPARATUS, INFORMATION PROCESSING METHOD, AND NON-TRANSITORY COMPUTER-READABLE MEDIUM STORING PROGRAM

(71) Applicant: TOYOTA JIDOSHA KABUSHIKI KAISHA, Toyota-shi (JP)

(72) Inventors: Xin JIN, Nagoya-shi (JP); Miharu HANAI, Obu-shi (JP)

(73) Assignee: TOYOTA JIDOSHA KABUSHIKI KAISHA, Toyota-shi (JP)

(21) Appl. No.: 16/170,835

(22) Filed: Oct. 25, 2018

(30) Foreign Application Priority Data
Nov. 6, 2017 (JP) 2017-214207

(51) Int. Cl. H04N 5/76; G06F 3/0481; G06F 3/16; H04N 5/445; G08G 1/137; B60R 1/00; G01C 21/36

(52) U.S. Cl. CPC H04N 5/76; G06F 3/04817; G06F 3/16; H04N 5/445; H04N 5/23203; B60R 1/00; G01C 21/3647; G01C 21/3697; G08G 1/137

(57) ABSTRACT

An information processing apparatus has a processor. The processor is configured to acquire a current position of a user, acquire an image captured when the user passes through a predetermined position, and make the image be displayed on a map screen in association with the predetermined position.

### INCORPORATION BY REFERENCE

The disclosure of Japanese Patent Application No. 2017-214207 filed on Nov. 6, 2017 including the specification, drawings and abstract is incorporated herein by reference in its entirety.

### BACKGROUND

### 1. Technical Field

The present disclosure relates to an information processing apparatus, an information processing method, and a non-transitory computer-readable medium storing a program.

### 2. Description of Related Art

In the related art, a technique that captures images outside a vehicle, such as ahead of the vehicle, or inside the vehicle using an in-vehicle camera (drive recorder) and stores the captured images in a storage device is known (for example, see Japanese Unexamined Patent Application Publication No. 2014-096632 (JP 2014-096632 A) and Japanese Unexamined Patent Application Publication No. 2008-082822 (JP 2008-082822 A)).

### SUMMARY

For example, in a case where a user does sightseeing, makes a trip, or the like while driving a vehicle, a case where the user captures and stores images outside the vehicle or inside the vehicle at a predetermined position, such as inside a landscape spot, in order to look back on a memory of sightseeing or trip has been examined. In this case, in the related art, the user manually captures and stores an image or the user manually selects an image to be stored among images automatically captured by the drive recorder. However, in this case, there is a problem in that the user needs a lot of effort to capture an image or select an image to be stored.

The disclosure provides an information processing apparatus, an information processing method, and a non-transitory computer-readable medium storing a program capable of allowing a user to comparatively easily look back on a memory of trip, or the like.

A first aspect of the disclosure relates to an information processing apparatus. The information processing apparatus includes a processor. The processor is configured to acquire a current position of a user, acquire an image captured when the user passes through a predetermined position, and make the image be displayed on a map screen in association with the predetermined position.

For this reason, the image captured when the user passes through the predetermined position is made to be displayed on the map screen in association with the predetermined position. Therefore, it is possible to allow the user to comparatively easily look back on a memory of a trip, or the like.

In the information processing apparatus according to the first aspect of the disclosure, the processor may be configured to make a route from a departure place to a destination in a history of movement of the user be displayed on the map screen and make the image be displayed on the map screen in association with the predetermined position on the route.

For this reason, the image captured when the user passes through the predetermined position is made to be displayed on the map screen in association with the predetermined position on the moving route of the user. Therefore, it is possible to allow the user to comparatively easily look back on a memory of a trip, or the like.

In the information processing apparatus according to the first aspect of the disclosure, the predetermined position may include at least one of a position set by the user, a position designated in a route shared by an other user, and a position with a comment or an image in the route shared by the other user.

For this reason, the image captured when the user passes through the position set by the user, the position designated in the route shared by another user, or the position with the comment or the image in the route shared by another user is made to be displayed on the map screen in association with the predetermined position. Therefore, it is possible to allow the user to comparatively easily look back on a memory of a trip, or the like.

In the information processing apparatus according to the first aspect of the disclosure, the processor may be configured to acquire a voice recorded when the user passes through the predetermined position and make the image and an operation icon for reproducing the voice be displayed on the map screen in association with the predetermined position.

For this reason, the image captured when the user passes through the predetermined position, and the voice are made to be displayed on the map screen in association with the predetermined position. Therefore, it is possible to allow the user to comparatively easily look back on a memory of a trip, or the like.

In the information processing apparatus according to the first aspect of the disclosure, the processor may be configured to acquire a voice collected when the user passes through the predetermined position, and in a case where a volume level of the acquired voice is equal to or higher than a threshold, acquire the image.

For this reason, the image captured in a case where the volume level of the voice is equal to or higher than the threshold when the user passes through the predetermined position is made to be displayed on the map screen in association with the predetermined position. Therefore, it is possible to allow the user to comparatively easily look back on a memory of a trip when the user became lively.

In the information processing apparatus according to the first aspect of the disclosure, the processor may be configured to acquire a comment input by the user to the predetermined position and make the image and the comment be displayed on the map screen in association with the predetermined position.

For this reason, the image captured when the user passes through the predetermined position, and the comment are made to be displayed on the map screen in association with the predetermined position. Therefore, it is possible to allow the user to comparatively easily look back on a memory of a trip, or the like.

In the information processing apparatus according to the first aspect of the disclosure, the processor may be configured to, in a case where a volume level of a voice collected when the user passes through the predetermined position is equal to or higher than a threshold, share the predetermined position and the image with terminals of users other than the user.

For this reason, the image captured in a case where the volume level of the voice is equal to or higher than the threshold when the user passes through the predetermined position is made to be shared. Therefore, it is possible to comparatively easily share a record of a trip when the user became lively with other users.

In the information processing apparatus according to the first aspect of the disclosure, the processor may be configured to, in a case where a comment to the predetermined position is input by the user, share the predetermined position, the image, and the comment with terminals of users other than the user.

For this reason, the image with the comment among the images captured when the user passes through the predetermined position is made to be shared. Therefore, it is possible to comparatively easily share a memory having a comparatively high degree of interest with other users.

In the information processing apparatus according to the first aspect of the disclosure, the processor may be configured to acquire an image captured with an imaging device mounted in a vehicle when the user passes through the predetermined position. For this reason, the image captured with a drive recorder or the like when the user passes through the predetermined position with the vehicle is made to be displayed on the map screen in association with the predetermined position. Therefore, it is possible to allow the user to comparatively easily look back on a memory of a trip, or the like with a vehicle.

In the information processing apparatus according to the first aspect of the disclosure, the processor may be configured to acquire an image outside the vehicle captured with the imaging device mounted in the vehicle when the user passes through the predetermined position.

In the information processing apparatus according to the first aspect of the disclosure, the processor may be configured to acquire an image of an inside of a vehicle captured with an imaging device mounted in the vehicle when the user passes through the predetermined position. For this reason, the image of the inside of the vehicle captured with a drive recorder or the like when the user passes through the predetermined position with the vehicle is made to be displayed on the map screen in association with the predetermined position. Therefore, it is possible to allow the user to comparatively easily look back on a memory of a trip, or the like with a vehicle.

In the information processing apparatus according to the first aspect of the disclosure, the processor may be configured to acquire an image of the user who is in a vehicle captured with an imaging device mounted in the vehicle when the user passes through the predetermined position. For this reason, the image of occupants with a drive recorder or the like when the user passes through the predetermined position with the vehicle is made to be displayed on the map screen in association with the predetermined position. Therefore, it is possible to allow the user to comparatively easily look back on a memory of a trip, or the like with a vehicle from the image of the user, a friend, or the like at a memorable place or the like.

A second aspect of the disclosure relates to an information processing method. The information processing method includes, with an information processing apparatus, acquiring a current position of a user, acquiring an image captured when the user passes through a predetermined position, and making the image be displayed on a map screen in association with the predetermined position.

A third aspect of the disclosure relates to a non-transitory computer-readable medium storing a program causing an information processing apparatus to perform a process. The process includes, acquiring a current position of a user, acquiring an image captured when the user passes through a predetermined position, and making the image be displayed on a map screen in association with the predetermined position.

According to the aspects of the disclosure, it is possible to allow the user to comparatively easily look back on a memory of a trip, or the like.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram showing a configuration example of a communication system according to an embodiment;

FIG. 2 is a diagram showing a hardware configuration example of a server according to the embodiment;

FIG. 3 is a diagram showing an example of a functional block diagram of a terminal and a server according to the embodiment;

FIG. 4A is a sequence diagram showing an example of a process of the communication system according to the embodiment;

FIG. 4B is a sequence diagram showing an example of a process of the communication system according to the embodiment;

FIG. 5 is a table showing an example of trip information; and

FIG. 6 is a diagram illustrating an example of a display screen of a terminal.

### DETAILED DESCRIPTION OF EMBODIMENTS

Hereinafter, an embodiment of the disclosure will be described referring to the drawings.

System Configuration

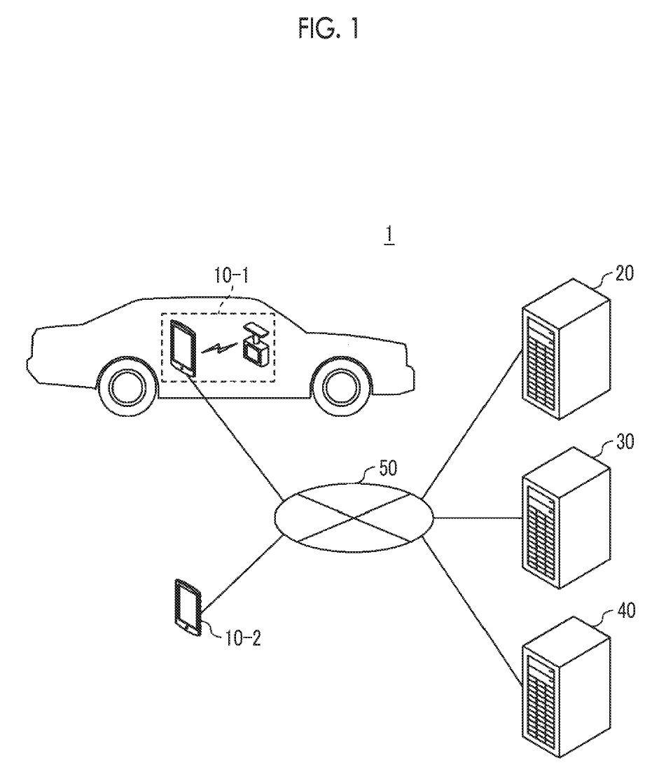

FIG. 1 is a diagram showing a configuration example of a communication system 1 according to an embodiment. In FIG. 1, the communication system 1 has terminals 10-1, 10-2 (hereinafter, in a case where there is no need for distinction from each other, simply referred to as “terminals 10”), a server 20, a social networking service (SNS) server 30, and a content providing server 40. The number of terminals 10 is not limited to two.

The terminals 10 and the server 20, and the terminals 10 and the SNS server 30 are connected in a communicable state, for example, through a network 50, such as the Internet, a mobile phone network, a wireless local area network (LAN), or a LAN. The server 20 and the content providing server 40 are connected in a communicable state through the network 50.

Each terminal 10 is, for example, an information processing apparatus (computer), such as a smartphone, a tablet personal computer (PC), a notebook PC, an in-vehicle camera (drive recorder) with a communication function, or a navigation device with a communication function. The in-vehicle camera is an example of “an imaging device mounted in a vehicle”. Each terminal 10 may have an internal camera (“imaging device”) that captures an image. Alternatively, each terminal 10 may be connected to an external camera in a wired or wireless manner.

Each terminal 10 may be constituted of a plurality of devices. For example, each terminal 10 may be constituted of a smartphone, an in-vehicle navigation device, and an in-vehicle camera. In this case, for example, the smartphone and the in-vehicle navigation device may be connected to perform communication in a short-distance wireless manner, and the in-vehicle navigation device and the in-vehicle camera may be connected to perform communication through a cable or the like. An image (still image or moving image) captured by the in-vehicle camera may be transmitted to the server 20 through the in-vehicle navigation device and the smartphone.

For example, each terminal 10 may be constituted of an in-vehicle navigation device with a communication function and an in-vehicle camera. In this case, for example, the in-vehicle navigation device and the in-vehicle camera may be connected to perform communication through a cable or the like. An image captured by the in-vehicle camera may be transmitted to the server 20 through the in-vehicle navigation device with the communication function.

Each terminal 10 may acquire data of a map or a route from the server 20 using an application for route guidance (navigation), and may perform navigation of moving using a vehicle, walking, a train, or the like. Each terminal 10 may transmit (upload) information regarding a route, along which the user moves, or a route, along which the user is moving, to the server 20 using navigation with the application. Each terminal 10 may also transmit information regarding a route, along which the user moves, or a route, along which the user is moving, to the server 20 without using navigation with the application.

Each terminal 10 automatically captures an image at a predetermined position, such as a landscape spot, and stores the image as trip information in the server 20. Here, each terminal 10 may capture, for example, an image outside a vehicle, such as ahead of the vehicle. Each terminal 10 may capture, for example, an image inside the vehicle, such as a user (occupant) who is in the vehicle. Each terminal 10 may capture an image outside the vehicle and an image inside the vehicle simultaneously, for example. Each terminal 10 displays the images included in the trip information stored in the server 20 on a map screen in association with the predetermined position. Each terminal 10 may store the images in the terminal 10, and may display the images on the map screen in association with the predetermined position. The trip information may include, for example, information regarding a moving route from a departure place to a destination, or the like. The trip information may include a via-point, a departure time, an arrival time, and a pin, a comment, an image captured by a user, or the like associated with a position on the route.

Each terminal 10 performs chat, image sharing, and the like with a group of friends or the like using a social networking service provided by the SNS server 30.

The server 20 is, for example, an information processing apparatus for a server, and manages the trip information uploaded from the terminals 10 for each of the users of the terminals 10. The server 20 may provide a service, such as navigation, to the terminals 10. The server 20 shares the trip information uploaded from each terminal 10 with users of other terminals 10 through the SNS server 30. The server 20 may share the trip information uploaded from each terminal 10 with users of other terminals 10 not through the SNS server 30.

The SNS server 30 is, for example, an information processing apparatus for a server, and provides a social networking service, such as group chat, to the terminals 10. The SNS server 30 transmits the trip information uploaded from each terminal 10 through the server 20 to other terminals 10 using the social networking service. The SNS server 30 may transmit the trip information to other terminals 10 using social media including Wiki, SNS, a blog, an image sharing site, and the like.

The content providing server 40 is, for example, an information processing apparatus for a server, and provides data, such as business hours of facilities, to the server 20.

Hardware Configuration

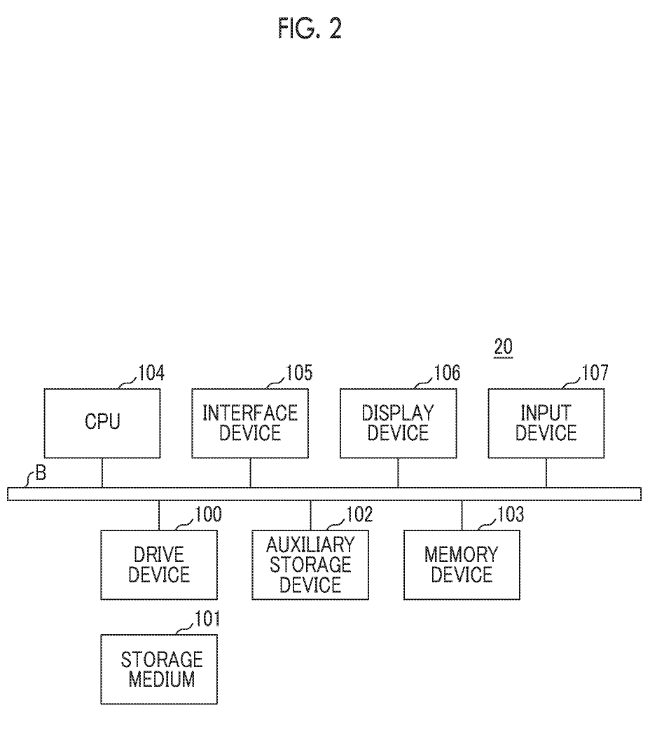

FIG. 2 is a diagram showing a hardware configuration example of the server 20 according to the embodiment. The server 20 of FIG. 2 has a drive device 100, an auxiliary storage device 102, a memory device 103, a CPU 104, an interface device 105, and the like connected to one another through a bus B.

An information processing program that realizes a process in the server 20 is provided, for example, by a storage medium 101. In a case where the storage medium 101 having the information processing program recorded thereon is set in the drive device 100, the information processing program is installed from the storage medium 101 to the auxiliary storage device 102 through the drive device 100. However, the installation of the information processing program is not indispensably performed from the storage medium 101, and may be downloaded from another computer through the network. The auxiliary storage device 102 stores the installed information processing program, and stores needed files, data, and the like.

The memory device 103 is, for example, a random access memory (RAM), and in a case where there is a start instruction of the program, reads and stores the program from the auxiliary storage device 102. The CPU 104 realizes functions related to the server 20 according to the program stored in the memory device 103. The interface device 105 is used as an interface for connection to the network.

As an example of the storage medium 101, a portable storage medium, such as a compact disk-read only memory (CD-ROM), a digital versatile disc (DVD) disk, or a universal serial bus (USB) memory, is exemplified. As an example of the auxiliary storage device 102, a hard disk drive (HDD), a flash memory, or the like is exemplified. Both of the storage medium 101 and the auxiliary storage device 102 correspond to a computer-readable storage medium.

The hardware configurations of the terminal 10, the SNS server 30, and the content providing server 40 may be the same as that of the server 20.

Functional Configuration

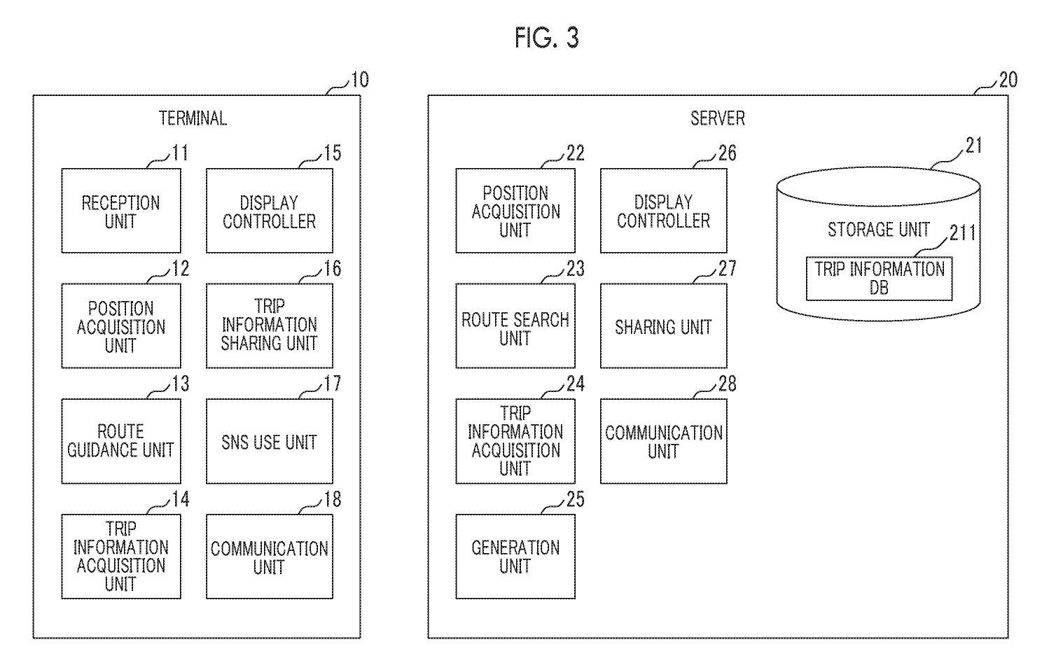

The functional configurations of the terminal 10 and the server 20 according to the embodiment will be described referring to FIG. 3. FIG. 3 is a diagram showing an example of a functional block diagram of the terminal 10 and the server 20 according to the embodiment.

Server 20

The server 20 has a storage unit 21. The storage unit 21 is realized using, for example, an auxiliary storage device or the like. The storage unit 21 stores a trip information database (DB) 211 and the like. Data stored in the trip information DB 211 will be described below.

The server 20 has a position acquisition unit 22, a route search unit 23, a trip information acquisition unit 24, a generation unit 25, a display controller 26, a sharing unit 27, and a communication unit 28. The position acquisition unit 22, the route search unit 23, the trip information acquisition unit 24, the generation unit 25, the display controller 26, the sharing unit 27, and the communication unit 28 represent functions that are realized by a process executed on the CPU of the server 20 by one or more programs installed on the server 20.

The position acquisition unit 22 acquires a current position of the terminal 10. The position acquisition unit 22 may acquire current position information acquired by a global positioning system (GPS) of the terminal 10 from the terminal 10, for example, while a navigation function or the like of the terminal 10 is being executed. The route search unit 23 searches for a route from a departure place to a destination.

The trip information acquisition unit 24 acquires an image captured and a voice recorded when the user of the terminal 10 passes through a predetermined position from the terminal 10. The trip information acquisition unit 24 acquires a comment or the like input by the user of the terminal 10.

The generation unit 25 generates trip information based on information acquired by the trip information acquisition unit 24, and stores the generated trip information in the trip information DB 211.

The display controller 26 makes the terminal 10 display the trip information stored in the trip information DB 211. Specifically, the display controller 26 makes the image, the comment, and the like be displayed on a screen (map screen) of the terminal 10, on which a map is displayed, in association with the predetermined position on the map based on the trip information.

The sharing unit 27 allows trip information of the user of the terminal 10 to be shared with other users. The sharing unit 27 makes the trip information be shared with other users using the social networking service provided by the SNS server 30, for example.

The communication unit 28 performs communication with the terminal 10, the SNS server 30, and the content providing server 40. The communication unit 28 receives a route search request, a route sharing request, and the like from the terminal 10. The communication unit 28 transmits the trip information to the SNS server 30 according to an instruction from the sharing unit 27.

Terminal 10

The terminal 10 has a reception unit 11, a position acquisition unit 12, a route guidance unit 13, a trip information acquisition unit 14, a display controller 15, a trip information sharing unit 16, an SNS use unit 17, and a communication unit 18. The reception unit 11, the position acquisition unit 12, the route guidance unit 13, the trip information acquisition unit 14, the display controller 15, the trip information sharing unit 16, the SNS use unit 17, and the communication unit 18 represent functions that are realized by a process executed on the CPU of the terminal 10 by one or more programs installed on the terminal 10.

The reception unit 11 receives an input operation from the user. The reception unit 11 receives, for example, an operation for designating a route, or the like. The position acquisition unit 12 acquires the current position of the terminal 10.

The route guidance unit 13 performs route guidance using a route from a destination to a departure place included in trip information shared by a user of another terminal 10-2 or a route received from the server 20. For example, the route guidance unit 13 may perform route guidance for a vehicle or may perform route guidance for walking.

The trip information acquisition unit 14 controls a camera and a microphone when the user of the terminal 10 passes through a predetermined position, and acquires an image captured with the camera and a voice collected with the microphone. Here, the predetermined position may be a region having a predetermined area. The predetermined position may be, for example, a region including a predetermined spot (hereinafter, referred to as a “predetermined place”) represented by a latitude, a longitude, and the like associated with a landscape spot or a facility, such as a commercial facility. The trip information acquisition unit 14 acquires a comment or the like input by the user of the terminal 10. For example, in a case where the distance between the current position of the terminal 10 and the predetermined place is equal to or less than a predetermined threshold, the trip information acquisition unit 14 may determine that the user of the terminal 10 passes through the predetermined position. In this case, the predetermined threshold may be set in advance according to the predetermined place. Alternatively, for example, in a case where the shortest distance between the current position of the terminal 10 and a predetermined range according to the predetermined place is equal to or less than a predetermined threshold, the trip information acquisition unit 14 may determine that the user of the terminal 10 passes through the predetermined position. Alternatively, for example, in a case where the distance between a road in a direction where the terminal 10 is moving currently and the predetermined place or the shortest distance between the road and a predetermined range according to the predetermined position is equal to or less than a predetermined threshold, the trip information acquisition unit 14 may determine that the user of the terminal 10 passes through the predetermined position.

The display controller 15 makes data of the image, the comment, and the like included in the trip information be displayed on the map screen in association with the predetermined position on the map according to an instruction from the server 20. Here, the display controller 15 may make data be displayed in association with the predetermined place included in the predetermined position. With this, since a plurality of pieces of data relating to the same facility is displayed in association with the same spot, it is possible to perform the display so as to more easily understand that the pieces of data are relative to the same facility.

The trip information sharing unit 16 shares the trip information used by the user of the terminal 10 with other terminals 10 using the server 20. For example, the trip information sharing unit 16 acquires the trip information from the server 20 or the SNS server 30. For example, the trip information sharing unit 16 uploads the trip information to the server 20.

The SNS use unit 17 performs chat, image sharing, and the like with a group including the users of other terminals 10 using the SNS server 30. In a case where an image of the trip information shared through the SNS is selected by the user, the SNS use unit 17 can edit the selected trip information with the trip information sharing unit 16.

The communication unit 18 performs communication with the server 20 and the SNS server 30. For example, the communication unit 18 transmits a route search request, a route sharing request, and the like to the server 20.

Process

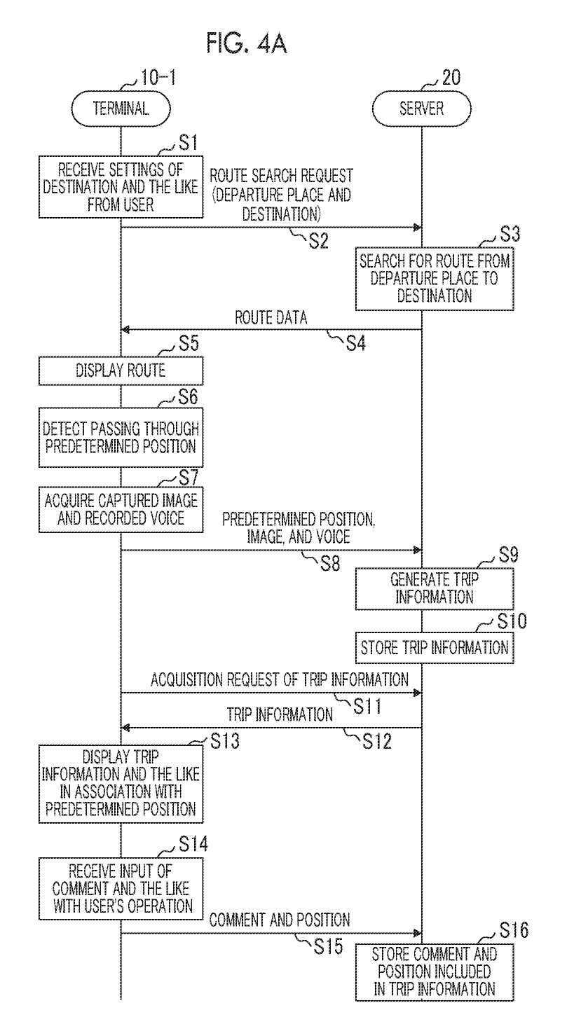

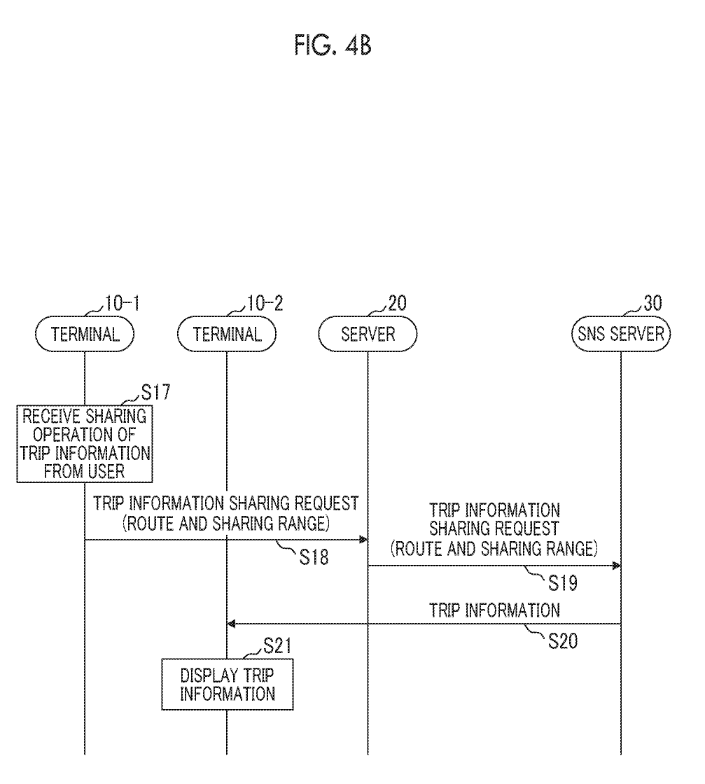

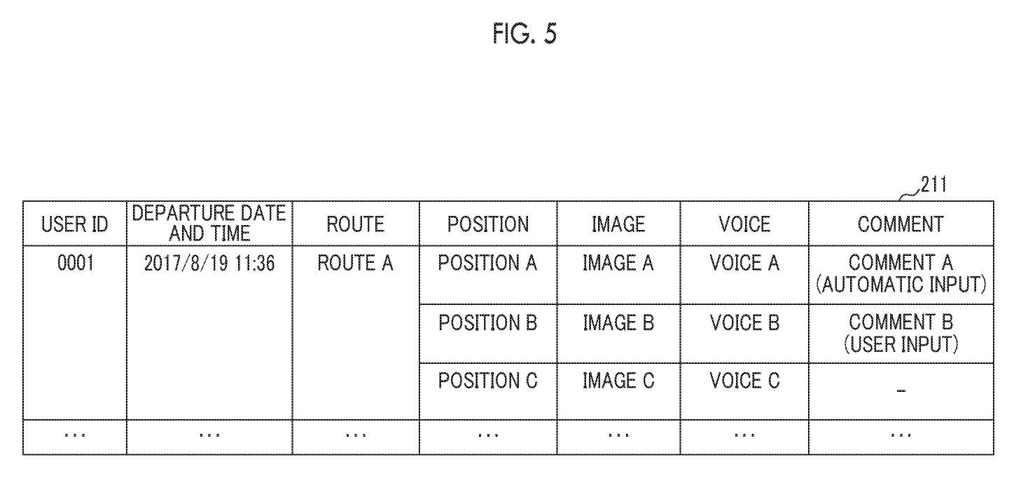

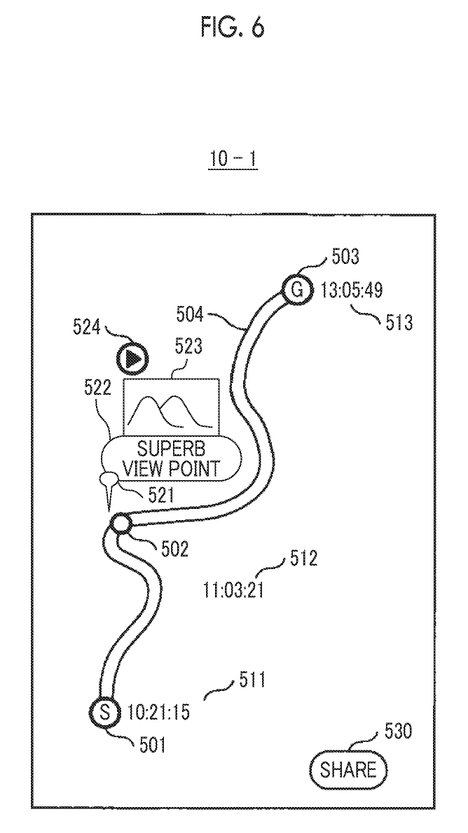

A process of the communication system 1 according to the embodiment will be described referring to FIGS. 4A to 6. FIGS. 4A and 4B are sequence diagrams showing an example of the process of the communication system 1 according to the embodiment. FIG. 5 is a diagram showing an example of trip information. FIG. 6 is a diagram illustrating an example of a display screen of the terminal 10-1.

In Step S1, the reception unit 11 of the terminal 10-1 receives setting of a destination, a departure place, and the like from the user. In a case where designation of the departure place is not received from the user, a current position of the terminal 10 or a position set in advance may be set as a departure place.

The route guidance unit 13 of the terminal 10-1 transmits a route search request including setting data, such as the destination, to the server 20 (Step S2). With this, setting data, such as the destination and the departure place, is acquired by the position acquisition unit 22 of the server 20.

The route search unit 23 of the server 20 searches for a route (moving route or route) from the departure place to the destination (Step S3), and transmits information of the searched route to the terminal 10-1 (Step S4).

The route guidance unit 13 of the terminal 10-1 displays the route received from the server 20 (Step S5). Instead of receiving setting of the destination and the like from the user with the reception unit 11, when the trip information shared by the user of another terminal 10-2 is designated from the user, the route guidance unit 13 may display a route from the destination to the departure place included in the trip information.

When the user of the terminal 10-1 is traveling along the route with a vehicle or the like, the trip information acquisition unit 14 of the terminal 10-1 detects that the user of the terminal 10-1 passes through a predetermined position from the current position of the terminal 10-1 acquired by the position acquisition unit 12 (Step S6). Here, the predetermined position is, for example, a position set by the user of the terminal 10-1, a position designated by the user or the like in the trip information shared by the user of another terminal 10-2, a position with a comment or an image given by the user or the like in the trip information shared by the user of another terminal 10-2, or the like. The position designated by the user or the like in the trip information shared by the user of another terminal 10-2 is, for example, a position set by the user of the terminal 10-2 in order to record an image at the time of moving of the user of the terminal 10-2.

The trip information acquisition unit 14 of the terminal 10-1 acquires an image captured at the predetermined position and a voice recorded at the predetermined position in a case where a predetermined condition is satisfied (Step S7). Here, in a case where the predetermined condition is satisfied, the trip information acquisition unit 14 makes the in-vehicle camera, the camera embedded in the terminal 10-1, or the like capture an image and makes the in-vehicle camera, the microphone embedded in the terminal 10-1, or the like collect a voice for a predetermined time.

The predetermined condition may be, for example, a case where the volume level of the voice collected by the microphone or the like at the predetermined position is equal to or higher than a predetermined threshold. With this, solely in a case where a user inside a vehicle becomes lively or shouts for joy in a landscape spot or the like, an image and a voice can be acquired. The predetermined condition may be, for example, a case where current date and time satisfies a condition of date and time associated with the predetermined position in the content providing server 40 or the like. With this, for example, when the current position is a spot for autumn leaves, solely in a case where the current date and time is a season of autumn leaves, an image and a voice can be acquired. Furthermore, for example, when the current position is a spot where the user can appreciate the sunset, solely in a case where the current date and time is a time slot where the sun sets, an image and a voice can be acquired.

The process for determining whether or not the predetermined condition is satisfied when the image and the voice are acquired may be executed in Step S9 by the trip information acquisition unit 24 of the server 20, instead of being executed in Step S7 by the trip information acquisition unit 14 of the terminal 10-1.

The communication unit 18 of the terminal 10-1 transmits the predetermined position, the image, and the voice to the server 20 (Step S8).

The generation unit 25 of the server 20 generates trip information including information having the image, the voice, and the like associated with the predetermined position acquired by the trip information acquisition unit 24, and information of the route from the departure place to the destination (Step S9). In a case where the trip information shared by the user of another terminal 10-2 is designated from the user in the terminal 10-1, the generation unit 25 of the server 20 may replace the image, the voice, and the like, associated with the predetermined position, included in the shared trip information with the image, the voice, and the like transmitted from the terminal 10-1 through the process of Step S8.

The generation unit 25 of the server 20 may automatically generate a comment to the predetermined position and may include the generated comment in the trip information. In this case, the generation unit 25 of the server 20 may generate a comment including position information of the predetermined position, date and time when the user passes through the predetermined position, the degree of liveliness inside the vehicle, a facility name or a description of a facility at the predetermined position, and the like. The degree of liveliness inside the vehicle may be calculated based on the magnitude of the volume level of the voice when the user passes through the predetermined position. For example, in a case where the volume level is equal to or higher than a predetermined threshold, the degree of liveliness inside the vehicle may be calculated in a five-step display. The facility name or the description of the facility at the predetermined position may be acquired from the content providing server 40 or the like.

The generation unit 25 of the server 20 stores the trip information in the trip information DB 211 in association with an identification (ID) of the user of the terminal 10-1, departure date and time, and the like (Step S10).

Information of the route from the departure place to the destination may be generated based on information of a history of positions where the user of the terminal 10 has actually moved, acquired by the position acquisition unit 22, or may be the route searched by the route search unit 23. Alternatively, in a case where route guidance using the trip information shared by the user of another terminal 10-2 is performed in the terminal 10-1, Information from the departure place to the destination may be the route included in the trip information.

In the example of FIG. 5, the trip information DB 211 stores items of a route, and an image, a voice, a comment, and the like to each position in association with a user ID and departure date and time. The user ID is the ID of the user of the terminal 10. The departure date and time is the date and time when the user departs from the departure place. The route is the route from the departure place to the destination, and may be represented by, for example, each node indicating an intersection or the like on a road to pass through from the departure place to the destination, and an order of passing through the nodes. Each image is the image captured at the predetermined position in Step S7 or an image captured by a user's operation. Each voice is a voice recorded at the predetermined position in Step S7 or a voice recorded by a user's operation. Each comment is the comment automatically generated to the predetermined position in Step S9 or a comment input by a user's operation in Step S14 described below.

The trip information acquisition unit 14 of the terminal 10-1 transmits an acquisition request of trip information associated with the departure date and time or the like designated by the user to the server 20 according to a user's operation (Step S11).

The display controller 26 of the server 20 transmits the trip information to the terminal 10-1 (Step S12). The display controller 15 of the terminal 10-1 displays the trip information on the map screen (Step S13). Here, as shown in FIG. 6, the image, the voice, the comment, and the like to each position included in the trip information are displayed on the map in association with each position. The route included in the trip information is also displayed on the map. With this, it is possible to allow the user to view a record of a trip through a moving route or an image during or after moving.

In FIG. 6, as a display example of trip information, an example of trip information after the user of the terminal 10-1 actually moves from a departure place to a destination during a trip or the like is shown. In the example of FIG. 6, a route 504 from a departure place 501 to a destination 503 by way of a via-point 502, a time 511 for departure or scheduled for departure from the departure place 501, a time 512 for passing through or scheduled for passing through the via-point 502, a time 513 for arrival or scheduled for arrival at the destination 503, a pin 521, a comment 522, an image 523, an icon for reproduction (“operation icon”) 524, and a share button 530 are displayed.

The pin 521 is, for example, an icon indicating the above-described predetermined position. The image 523 is an acquired image captured when the user passes through the above-described predetermined position. A thumbnail of the image may be displayed. The icon for reproduction 524 is an icon for reproducing an acquired voice collected when the user passes through the above-described predetermined position. The image and the voice may be collectively stored as a single file.

The reception unit 11 of the terminal 10-1 receives an input of a comment (character information) at a position selected by the user on the map of the screen according to a user's operation (Step S14). The trip information acquisition unit 14 of the terminal 10-1 transmits the input comment and the input position of the comment on the map to the server 20 (Step S15).

The generation unit 25 of the server 20 includes the comment and the input position of the comment acquired by the trip information acquisition unit 24 in the trip information, and stores the trip information in the trip information DB 211 (Step S16). With this, when the terminal 10-1 acquires the trip information, the comment is also displayed in association with the position on the map where the comment is input.

The trip information sharing unit 16 of the terminal 10-1 receives an operation to designate trip information to be shared and a range of users sharing the trip information from the user (Step S17).

Here, the trip information sharing unit 16 of the terminal 10-1 receives designation of the ID of each user included in a group sharing the trip information as the range of users sharing the trip information. Furthermore, the trip information sharing unit 16 of the terminal 10-1 may receive designation of a talk room (chat room) of the group sharing the trip information in the SNS server 30.

The trip information sharing unit 16 of the terminal 10-1 transmits a route sharing request including data of the trip information and the range to the server 20 (Step S18).

The sharing unit 27 of the server 20 transmits the trip information and the range of users sharing the trip information to the SNS server 30 (Step S19). Here, the sharing unit 27 of the server 20 may convert the ID of each user included in the group sharing the route received in Step S11 to the ID of each user managed on the SNS server 30 and transmit the ID of each user managed on the SNS server 30 as the range of users sharing the trip information. In this case, a correspondence table of the ID of the user managed on the server 20 and the ID of the user managed on the SNS server 30 may be set in the server 20 in advance.

Here, the sharing unit 27 may allow solely an image and a voice satisfying a predetermined condition among images and voices included in the trip information to be shared by the SNS server 30.

The predetermined condition may be, for example, a case where a volume level of a voice collected by the microphone or the like at the predetermined position is equal to or higher than a predetermined threshold. The predetermined condition may be, for example, a case where the current date and time satisfies a condition of recommended date and time associated with the predetermined position. The predetermined condition may be, for example, a case where a comment to the predetermined position is input by the user. With this, it is possible to share solely an image and a voice of a place with a comment having a comparatively high degree of interest of the user.

The SNS server 30 transmits the received trip information of the terminal 10-2 of each user included in the group sharing the route (Step S20).

The SNS use unit 17 of the terminal 10-2 of the user as a sharing destination displays the trip information received from the SNS server 30 on a talk room screen of the group designated from the user of the terminal 10-1 (Step S21).

The trip information sharing unit 16 of the terminal 10-2 performs edition, such as addition or deletion, of a pin, a comment, an image, and the like associated with a position on the route in the shared trip information according to an operation from the user. In this case, the trip information sharing unit 16 of the terminal 10-2 can upload the edited trip information to the server 20 and can allow the trip information to be shared with the terminal 10-1. The trip information sharing unit 16 of the terminal 10 may directly upload the trip information to the SNS server 30 instead of uploading the trip information to the SNS server 30 through the server 20.

In a case where the user does sightseeing, makes a trip, or the like while driving the vehicle, a case where the user desires to capture and store images outside the vehicle or inside the vehicle at a landscape spot or the like in order to look back on a memory of sightseeing or trip has been examined. In this case, in the related art, the user manually captures and stores an image or the user manually selects an image to be stored among images automatically captured by the drive recorder. However, in a case where an image is captured manually, there is a problem in that the user may look at a landscape and miss a chance to capture an image. In a case where an image is selected from images captured by the drive recorder, there is a problem in that an old image may be erased for capturing a new image according to the storage capacity of the drive recorder.

As described above, according to the embodiment, the current position of the user is acquired, an image captured when the user passes through the predetermined position is acquired, and the image is made to be displayed on the map screen in association with the predetermined position. With this, for example, when the user passes through a position, such as a landscape spot or a sightseeing spot, it is possible to automatically capture an image of scenery ahead of the vehicle, an expression of the user inside the vehicle, or the like, and to display the captured image in association with the position. With this, it is possible to allow the user to comparatively easily look back on a memory of a trip, or the like.

Although the embodiment of the disclosure has been described above in detail, the disclosure is not limited to such a specific embodiment described above, and various modifications and alterations may be made without departing from the spirit and scope of the disclosure described in the claims.

The functional units of the terminal 10 and the server 20 may be realized by, for example, cloud computing constituted of one or more computers. A process of at least a part of the functions of the terminal 10 and the SNS server 30 may be executed in the server 20. A process of at least a part of the functional units of the server 20 may be executed in the terminal 10.

In the embodiment, the terminal 10 and the server 20 are an example of an information processing apparatus. The position acquisition unit 12 or the position acquisition unit 22 is an example of a “first acquisition unit”. The trip information acquisition unit 14 or the trip information acquisition unit 24 is an example of a “second acquisition unit”.

What is claimed is:

1. An information processing apparatus comprising a processor configured to
acquire a current position of a user,
acquire an image captured when the user passes through a predetermined position, and
make the image be displayed on a map screen in association with the predetermined position.

2. The information processing apparatus according to claim 1, wherein the processor is configured to
make a route from a departure place to a destination in a history of movement of the user be displayed on the map screen, and
make the image be displayed on the map screen in association with the predetermined position on the route.

3. The information processing apparatus according to claim 1, wherein the predetermined position includes at least one of a position set by the user, a position designated in a route shared by an other user, and a position with a comment or an image in the route shared by the other user.

4. The information processing apparatus according to claim 1, wherein the processor is configured to
acquire a voice recorded when the user passes through the predetermined position, and
make the image and an operation icon for reproducing the voice be displayed on the map screen in association with the predetermined position.

5. The information processing apparatus according to claim 1, wherein the processor is configured to
acquire a voice collected when the user passes through the predetermined position, and
in a case where a volume level of the acquired voice is equal to or higher than a threshold, acquire the image.

6. The information processing apparatus according to claim 1, wherein the processor is configured to
acquire a comment input by the user to the predetermined position, and
make the image and the comment be displayed on the map screen in association with the predetermined position.

7. The information processing apparatus according to claim 1, wherein the processor is configured to, in a case where a volume level of a voice collected when the user passes through the predetermined position is equal to or higher than a threshold, share the predetermined position and the image with terminals of users other than the user.

8. The information processing apparatus according to claim 1, wherein the processor is configured to, in a case where a comment to the predetermined position is input by the user, share the predetermined position, the image, and the comment with terminals of users other than the user.

9. The information processing apparatus according to claim 1, wherein the processor is configured to acquire an image captured with an imaging device mounted in a vehicle when the user passes through the predetermined position.

10. The information processing apparatus according to claim 9, wherein the processor is configured to acquire an image outside the vehicle captured with the imaging device mounted in the vehicle when the user passes through the predetermined position.

11. The information processing apparatus according to claim 1, wherein the processor is configured to acquire an image of an inside of a vehicle captured with an imaging device mounted in the vehicle when the user passes through the predetermined position.

12. The information processing apparatus according to claim 1, wherein the processor is configured to acquire an image of the user who is in a vehicle captured with an imaging device mounted in the vehicle when the user passes through the predetermined position.

13. An information processing method comprising, with an information processing apparatus:
acquiring a current position of a user;
acquiring an image captured when the user passes through a predetermined position; and
making the image be displayed on a map screen in association with the predetermined position.

14. A non-transitory computer readable medium storing a program causing an information processing apparatus to perform a process, the process comprising:
acquiring a current position of a user;
acquiring an image captured when the user passes through a predetermined position; and
making the image be displayed on a map screen in association with the predetermined position.
